(19) United States
(12) Patent Application Publication
(10) Pub. No.: US 2016/0337174 A1
(43) Pub. Date: Nov. 17, 2016

(54) AUTOMATED NETWORK PEERING IN A SOCIAL-NETWORK MODEL

(71) Applicants: David Francis Jorm, Indooroopilly (AU); Al Burgio, Santa Clara, CA (US); Thomas Madej, Santa Clara, CA (US); William B. Norton, Santa Clara, CA (US); Paul Gampe, Santa Clara, CA (US)

(72) Inventors: David Francis Jorm, Indooroopilly (AU); Al Burgio, Santa Clara, CA (US); Thomas Madej, Santa Clara, CA (US); William B. Norton, Santa Clara, CA (US); Paul Gampe, Santa Clara, CA (US)

(21) Appl. No.: 14/713,783

(22) Filed: May 15, 2015

(51) Int. Cl. H04L 12/24; H04L 29/08; H04L 12/46

(52) U.S. Cl. CPC H04L 41/0803; H04L 12/4641; H04L 67/02; H04L 41/0886

(57) ABSTRACT

Systems are disclosed for automating peering of Autonomous-Systems (ASs). ASs may be registered to a web-based platform. AS Numbers may be provided, profiles generated, and/or peering policies set during registration for presentations enabling evaluation of potential peering sessions between ASs. The web-based platform may automatically represent a peering request, ensure compliance with peering policies, and/or represent a negotiated peering session in a generalized routing policy language. An implementation module may automatically translate the representation to provide a physical connection between ASs in the peering session at a switch system to which they are connected. Also, the implementation module may automatically translate the representation into a distribution configuration implementable on and pushed to one or more routers. The routers may implement the distribution configuration pushed to them to advertise routing information for the peering session to the ASs via preexistent sessions with additional routers in the ASs.

### FIELD OF THE INVENTION

This disclosure relates to networking computing devices and, more particularly, to the interconnection of networks.

### BACKGROUND OF THE INVENTION

An enormous number of computer networks all around the world share interconnections to form the global system that is the internet. The many computer networks that make up the internet can be identified and characterized in many different ways, including in terms of the administration of those networks. For example, networks are identified as Autonomous Systems (ASs) where a collection of one or more interconnected networks and/or subnetworks, which may share one or more Internet Protocol (IP) routing prefixes, are under the control of a common administrator. ASs are also often identified and characterized by the presentation of a common routing policy to the internet.

The end-to-end-reachability principle behind the internet, according to which any host connected to the internet can, generally speaking, can reach any other host, entails that an AS gains access to the internet through interconnection with one or more networks previously connected to the internet. Interconnections between ASs can be desirable for a number of additional reasons. For example, interconnections can increase capacity, control of traffic, and redundancy. Interconnections may be used to avoid bottlenecks, create a support network, and provide the reliability and flexibility to achieve certain guarantees of traffic bandwidth and overall quality.

Interconnections between networks can be predicated on different types of relationships. For example, in one relationship, one network sells access and/or bandwidth to another network that pays settlement to the first, or transit, network. As an alternative, a first, separately-administered network and a second, separately-administered network may voluntarily agree to interconnect with one another in a non-transitive relationship where a first separately-administered network may have access to the second, separately-administered network, but not to additional networks connected to the second, separately-administered network and external to the second, separately-administered network and vise versa. Such relationships are known in the present application as peering. Often in such a peering relationship no payment of settlement from one network to the other is involved, or is significantly reduced. In such a relationship, although the separately-administered networks are interconnected to exchange traffic with one another, each separately-administered network retains its own revenue and makes no payment, or significant payment, to the other. However, peering may also include forms of paid peering where payments are made to one network in exchange for performance improvements that accrue from a direct connection to the network to which payments are made.

Despite the significant benefits of peering, many potential peering advantages go unrealized because of obstacles to finding, identifying, and/or negotiating peering relationships. Such activities are traditionally engaged in and/or performed manually, involving actions such as face-to-face communications and/or email exchanges. In addition to the agreement to avoid payment of settlement, peering requires a physical interconnection of the separately-administered networks, together with an exchange of routing information. These additional requirements present further obstacles. For example, although an AS-network-level Gateway Protocol (AGP), like Boarder Gateway Protocol (BGP), may be used to advertise network routes for a peering session, actual configuration involves manual interaction with a configuration tool or interface on the relevant routers. Reducing such obstacles holds the promise of the further realization of peering benefits.

### BRIEF DESCRIPTION OF THE DRAWINGS

In order that the advantages of the disclosures herein will be readily understood, a more particular description will be rendered by reference to specific examples and/or embodiments illustrated in the appended drawings. Understanding that these drawings depict only explanatory examples and/or typical embodiments and are not, therefore, to be considered limiting in scope, the invention will be described and explained with additional specificity and detail through use of the accompanying drawings, in which:

FIG. 1 is a schematic block diagram of separately-administered networks, or Autonomous Systems (ASs), in the internet, together with a peering relationship between a pair of separately-administered networks facilitated at an Internet Exchange Point (IXP), in accordance with examples;

FIG. 2 is a schematic block diagram of the use of cloud infrastructure to extend peering capabilities from a localized IXP to multiple IXPs and/or access points on a geographically large, and even intercontinental scope of inclusion, in accordance with examples;

FIG. 3 is a schematic block diagram of the use of peering infrastructure together with a web-based application and a database to facilitate peering sessions in a social-network model, in accordance with examples;

FIG. 4 is a schematic block diagram of the presentation of profiles of various separately-administered networks with various corresponding peering policies by a web-based application, for evaluation as potential peering targets, in accordance with examples;

FIG. 5 is a schematic block diagram of the automation of a peering request representation and the negotiation and characterization of a peering session, in accordance with examples;

FIG. 6 is a schematic block diagram of the automation of a peering session implementation, including translation of the peering session characterization into a configuration pushed to a switch system to implement a physical connection between the participating, separately-administered networks and further translation of the characterization to another configuration implementing an AS-network-level Gateway Protocol (AGP) on cloud-based routers, which maintain sessions with routers in the separately-administered networks, to advertise routing information to the separately-administered networks, in accordance with examples;

FIG. 7 is a flow chart of steps for, in accordance with examples, using a web-based application in a social-network like manner to automate the presentation, negotiation, and characterization of a peering session; and

FIG. 8 is a flow chart of steps for automating implementation of a peering session between separately-administered networks by translating a characterization of the peering sessions into configurations pushed to hardware to provide a physical connection and the exchange of routing information between the separately-administered networks, in accordance with examples.

### DETAILED DESCRIPTION

It will be readily understood that the components of the present invention, as generally described and illustrated in the figures herein, can be arranged and designed in a wide variety of different configurations. Thus, the following more detailed description, as represented in the figures, is not intended to be limiting in scope, as claimed, but is merely representative of certain examples. The presently described examples will be best understood by reference to the drawings, wherein like parts are designated by like numerals throughout.

To address problems and obstacles to the realization of the advantages of peering separately-administered networks, such as those discussed above in the background section, several innovations are disclosed herein. A brief overview of some of such innovations, leaving out certain aspects and various details for further discussion below, is set forth here. For example, a web-based application may be implemented on a system of servers communicatively coupled to a database stored on a set of storage devices. Such a web-based application may include a mobile interface to facilitate access of the web-based application from mobile devices.

The database may include profiles for separately-administered networks, which may include information such as an Autonomous System Number (ASN) and/or values for one or more network metrics. In some examples, a profile may also include an automated peering policy setting guidelines for peering with another separately-administered network. The information for the profiles may be stored by the web-based application in the database upon registration of the corresponding, separately-administered network with the web-based application.

The web-based application may reduce obstacles to the realization of the benefits of peering by helping to identify and/or evaluate peering opportunities and/or automate the negotiation and/or implementation of a peering session. To help identify, evaluate, and/or otherwise enable the interconnections involved in peering sessions between separately-administered networks, the web-based application may, for example, provide a social-network platform for such interconnections. To facilitate such interconnections in a social-network manner, the web-based application may, for example, be operable to provide, to a party responsible for a first, separately-administered network in the database, profiles for multiple, additional, separately-administered networks in the database.

The web-based application may also be operable to represent a peering request to a second, separately-administered network selected, by the responsible party, from the multiple additional networks to peer with the first network. Additionally, the web-based application may automatically negotiate a peering session of the first, separately-administered network and the second, separately-administered network by verifying, and/or taking steps to insure, compliance with an automated peering policy of the second, separately-administered network. To accommodate implementation of the negotiated peering session within a large range of scenarios, involving differing hardware and/or standards, the web-based application may also be operable to automatically define a general peering session specification/characterization. The specification/characterization may characterize the negotiated peering session for the first, separately-administered network and the second, separately-administered network in a generalized routing-policy language, with information from corresponding profiles and/or ASNs, that may later be translated for application in wide variety of different scenarios.

As can be appreciated, the functionalities of the web-based application may also serve to overcome obstacles to identifying, negotiating, and/or characterizing peering sessions. Additional obstacles may be overcome by automating processes involved in implementing peering sessions and/or aspects thereof. For example, an automatic implementation module, communicatively coupled to the web-based application, may be operable to receive the specification/characterization from the web-based application.

The automatic implementation module may be operable to translate, from the generalized specification/characterization, a first configuration implementable to provide a physical connection between the first, separately-administered network and the second, separately-administered network. In some examples, the automatic implementation module may be operable to push this first configuration to a switch and/or system of switches. The automatic implementation module may tailor the first configuration to specific hardware and/or standards applicable to the switch and/or the system of switches. The switch, and/or system of switches, may provide support and/or infrastructure, for a physical communication layer between the pair of separately-administered networks selected for the peering session and connected to ports of the switch and/or system of switches such that implementation of the first configuration results in a physical connection between the first, separately-administered network and the second, separately-administered network.

In a similar manner, the automatic implementation module may be operable to translate, from the generalized specification/characterization, a second configuration implementable by an AS-network-level Gateway Protocol (AGP), like Boarder Gateway Protocol (BGP), to advertise routing information for the peering session to routers in the separately-administered networks participating in the peering session. The automatic implementation module may provision the second configuration to cloud-based routers, maintaining sessions with routers in the first, separately-administered network and the second, separately-administered network. These cloud-based routers may serve as AGP speakers, such as, without limitation, BGP speakers, over which the routing policies for the peering session may be advertised. As before, the automatic implementation module may tailor the second configuration to the AGP, the AGP speakers, and/or one or more routers at the first, separately-administered network and/or the second, separately-administered network.

To better explain additional aspects of the innovations disclosed herein, additional discussion of the environment in which such innovations are provided may be helpful. Such discussion also provides context with which to better understand the terms used herein. Certain aspects of this environment, together with aspects of the disclosed invention are discussed below with respect to the following figures.

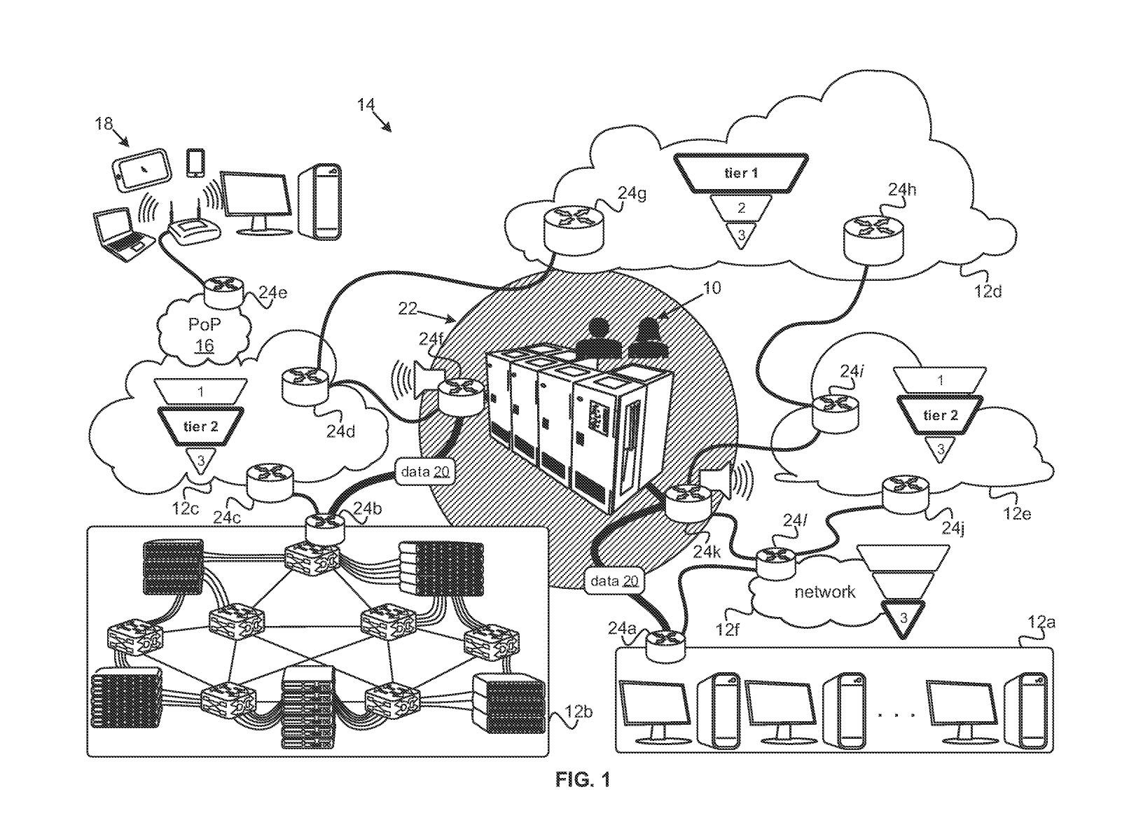

Referring to FIG. 1, a peering session 10 between two separately-administered networks 12a, 12b is depicted in the broader context of a localized portion of the internet 14. The portion of the internet 14 depicted includes several separately-administered networks 12a-f. One or more of these separately-administered networks 12a-f may qualify as an Autonomous System (AS), meaning that the separately-administered network 12 may have an assigned AS Number (ASN), be maintained under common administration, represent a common routing policy to the internet, and/or a include a collection of Internet Protocol (IP) routing prefixes. Also depicted, for the sake of providing context, is a Point of Presence (PoP) 16, which may be renting space and infrastructure from a large tier-2 network. The PoP 16 may function as an ISP servicing a home network 18 with a wireless access point connecting multiple different types of devices.

Such separately-administered networks 12a-f may be of differing sizes and characteristics. For example, in terms of relationships defined to address the costs of traffic and the infrastructure that supports it, networks 12 are commonly characterized into one of three tiers. A tier 1 network 12d, according to a common standard, is able to access most any other network 12 on the internet 14 without having to pay settlements to another network 12. Conversely, tier 2 networks 12c, 12e commonly pay other networks 12d to reach certain networks 12 on the internet 14. Such payments are known as settlements, or the purchase of transit. Nevertheless, tier 2 networks 12c, 12e also commonly agree with other networks 12 to mutually carry traffic for one another without cost, or significant cost, in a relationship known as peering. Internet Service Providers (ISPs) provide one common example of tier 2 networks.

A tier 3 network 12f is often characterized by reliance on one or more additional networks 12e to which settlement is paid to access the internet 14. Tier 3 networks 12 may be, without limitation, a small, regional ISP 12f, an enterprise-level network 12a, and/or one or more specialized networks 12b. Tier 2 networks 12c, 12e are not the only networks that can benefit from peering. Two separately-administered networks 12a, 12b are depicted as having established a peering session 10 in FIG. 1. In some instances, tier 2 and tier 3 networks 12 may also enter into a peering relationship with each other. Tier 1 networks may also enter peering relationships with other networks 12. The conditions under which one network 12 will peer with another network 12 may be formalized by the first network into a peering policy.

Networks 12a, 12b that have agreed to a peering relationship may enter into a peering session 10. Typically, peering sessions 10 are maintained for significant periods of time, periods of time which may be measured in years. With respect to the peering session 10 depicted in FIG. 1, the first, separately-administered network 12a may be a computer network 12a for a large enterprise, such as a business, or a non-profit, under common administration. The first, separately-administered network 12a may operate as a single network or include multiple subnetworks and may interconnect multiple work stations, and/or any other number of devices related to the enterprise, together. Additionally, the first, separately-administered network 12a may generate large amounts of data 20. The data 20 may require analysis that the first, separately-administered network 12a does not have the infrastructure to provide.

The size of the data 20 may be such that a more specialized data-processing network 12b, or data center 12b, running one or more data-processing applications, such as, without limitation, a Map/Reduce application, may be called for to analyze the data 20. The second, separately-administered network 12b provides an example of such a specialized, data-processing network 12b. The second, separately-administered network 12b may include multiple intermediate network devices, or switches, connecting multiple hosts with Central Processing Units (CPUs) and memory operable to execute coordinated data processing applications.

An arrangement may be entered into such that the second, separately-administered network 12b may process the data 20 from the first, separately-administered network 12a. However, the data 20 needs to be transferred from the first, separately-administered network 12a to the second, separately-administered network 12b. The first, separately-administered network 12a may rely on an ISP 12f to provide general access to the internet 14 and may try to transfer the data 20 via the ISP 12f to the second, separately-administered network 12b.

However, the circuitous route that would be required is inefficient, may be unreliable, may raise security issues, may require the purchase of additional bandwidth, and may outstrip the capacity of the ISP 12f. These considerations are compounded not only by the size of the data 20, but by the considerations that the ISP 12f would not likely be designed to handle the traffic efficiently and/or that additional networks 12 may be relied upon. These obstacles may be avoided and many additional benefits may be realized if the ISP 12f could be circumvented by a direct peering session 10 between the first, separately-administered network 12a and the second, separately-administered network 12b.

From the standpoint of the second, separately-administered network 12b, such a peering session 10 may also be advantageous. The second, separately-administered network 12b may want to remove the aforementioned obstacles to using its services from potential clients. Additionally, the second, separately-administered network 12b may have its own reasons for preferring a fast and reliable means for transferring the data 20. Consequently, both parties may be amenable to agreeing to a peering session 10.

However, a peering session 10 also requires a physical connection between the two networks 12a, 12b engaged in the peering session 10. An Internet Exchange Point (IXP) 22, or some other form of localized physical infrastructure providing opportunities for direct interconnection 22, such as, without limitation, a data center or collocation center, may provide the means for such a physical connection. Costs for the IXP infrastructure 22 may be shared by the participants. An IXP 22 may provide a switch, or system of switches, to which networks 12a-12f participating in the IXP 22 may connect. Consequently, upon agreement between participating parties, the switch, or system of switches, may be configured to provide a physical interconnection between networks 12a, 12b.

Additionally, since hosts in different, separately-administered networks 12a-12f, or Autonomous Systems 12a-12f, have different broadcast domains for layer-two networking protocols, interactions between such networks 12a-12f may rely on layer-three technologies, such as routers 24a-241. Similarly, in the peering session 10 depicted, layer-two/switching addresses are insufficient for communications between hosts in the first, separately-administered network 12a and the second, separately-administered network 12b. For communications between hosts in the two networks 12a, 12b, routing information is provided to the relevant routers 24a, 24b, or systems of routers 24 pertaining to the two participating networks 12a, 12b. Hence, in addition to an agreement and the physical connection discussed above, the peering session 10 also requires an exchange of routing information.

The sharing of routing information between Autonomous Systems 12a-12f, or separately administered networks 12a-12f, may be accomplished by use of one of various types of path vector protocols and/or distance vector protocols, such as, for example and without limitation, an AS-network-level Gateway Protocol (AGP), such as, without limitation, Border Gateway Protocol (BGP). Several different types of BGP may also be utilized, such as without limitation, BGP version 3, BGP version 4, and Exterior BGP, with codifications appearing, for example and without limitation, in Request For Comments (RFC)-4271 and/or RFC-1771. Another, non-limiting example may include Signaling System 7 (SS7). A future standard, such as, without limitation, Loc/ID separation Protocol (LISP) and/or, without limitation, a protocol as outlined in RFC-3221 may also be utilized.

Such a protocol may provide a protocol for the exchange of routing information, such as, without limitation, routing table information, between two routers 24, such as two gateway routers 24, pertaining to two different ASs. In such a protocol, a router 24 may serve the role of a protocol speaker 24f, 24k, such as an AGP speaker or BGP speaker 24f, 24k, by advertising to another router 24a, 24b in a different, separately-administered network, or AS 12a, 12b, the routing information.

In the context of the peering session 10, one or more routers 24f, 24k at an IXP 22, with connections to a first router 24a in the first, separately-administered network 12a and a second router 24b in the second, separately-administered network 12b, may serve as protocol speakers, such as BGP speakers 24f, 24k. These protocol speakers 24f, 24k may be operable to advertise the requisite network routes, or routing information, to the participating networks 12a, 12b of the peering session 10. However, the protocol speakers 24f, 24k are first configured to provide the information to the routers 24a, 24b in the participating networks 12a, 12b in a usable format. Typically, the configuration of a protocol speaker 24f, 24k is performed manually, such as by means of a configuration tool or other interface for the routers 24f, 24k, thereby presenting another obstacle to the realization of the peering session 10.

Additionally, an IXP 22, by its nature as a common point at which multiple, separately-administered networks 12a-12f are connected on a shared set of switches, is localized to a relatively small geographic area. Consequently, obstacles to peering sessions 10 may arise inasmuch as the IXP 22 may not provide the infrastructure for a physical connection and/or the exchange of routing information for a large number of networks 12 with infrastructure largely, or entirely, out of the geographic scope of the IXP 22. This will be the case for most networks 12, resulting in missed opportunities for peering sessions 10, even where they are identified, due to an underlying lack of infrastructure. Innovations overcoming these obstacles are discussed below with respect to the following figure.

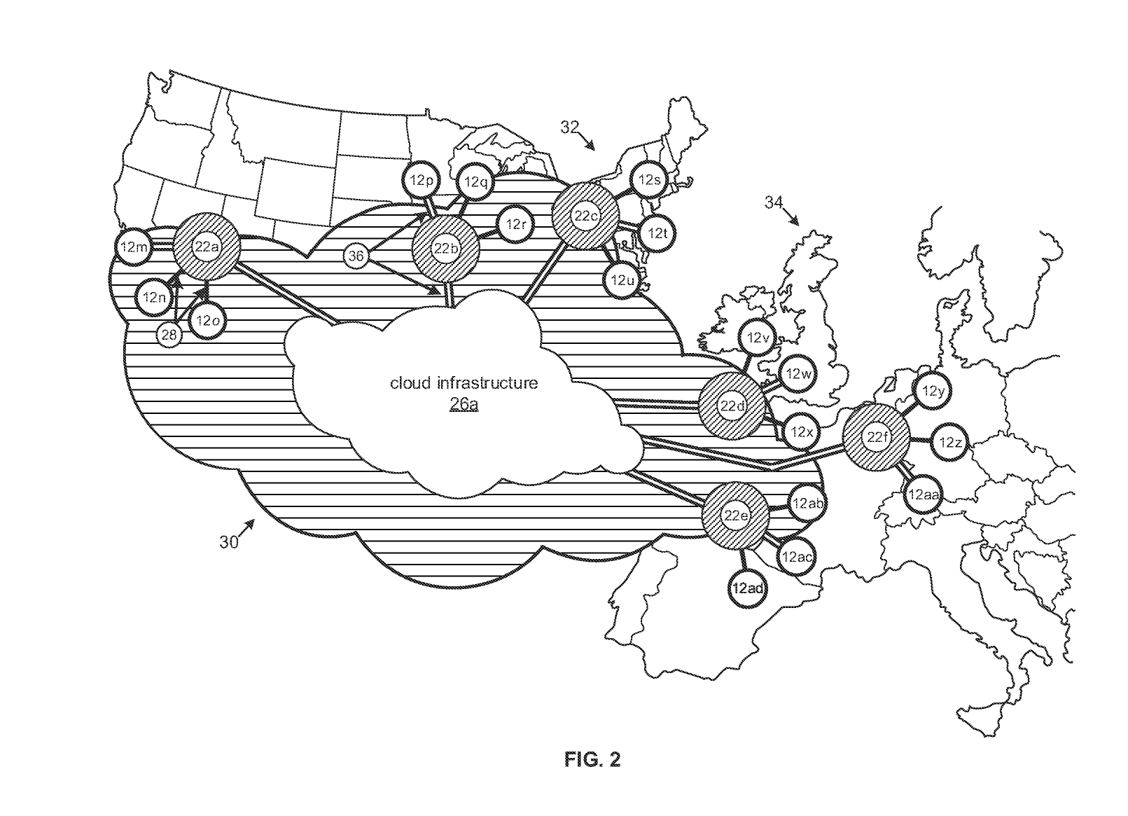

Referring to FIG. 2, innovations in cloud infrastructure 26a are depicted that may be used to extend peering capabilities from a localized IXP 22 to multiple IXPs 22a-e, data centers, collateral centers, or the like 22a-22f. The cloud infrastructure 26a may provide a system of switches and routers, together with gateways implementing an AGP, such as BGP, to provide cloud-based interconnections in a manner analogous to a Network as a Service (NaaS), but for providing interconnections for separately-administered networks or ASs 12m-12ad. Additional information about an example of such cloud infrastructure 26a may be found in World Intellectual Property Organization (WIPO) International Publication Number WO 2014/059550 A1, entitled “Method and Apparatus for a Distributed Internet Architecture,” the teachings of which being incorporated herein by reference.

Individual networks 12n, 12o may continue to engage in localized peering 28, the connections for which being indicated in FIG. 2 by the relatively thin black lines, facilitated by local IXPs 22a-22e, which may, for example, cover a metropolitan area. However, the cloud infrastructure 26a may be used to expand a peering-domain footprint 30 to cover large geographic areas. Indeed, FIG. 2 depicts a potential for a peering-domain footprint 30 to cover not only the continental United States 32, but also intercontinental geographies, including, for example, member States of the European Union 34. The double-lined bars depicted leading from separately administered networks 12m, 12p, 12t, 12w, 12aa, 12ac to IXPs 22a-22e, and further to the cloud infrastructure 26a demonstrate the potential for separately-administered networks 12m-12ad to engage in remote peering sessions 36 across the entire peering-domain footprint 30. For example, a separately-administered network 12m in San Francisco may enter into a peering relationship with a separately-administered network 12w in London, England, by means of local IXPs 22a, 22d and the cloud infrastructure 26a.

As can be appreciated, the expanded, peering-domain footprint 30 may greatly expand the universe of potential peering opportunities with greatly increased numbers of ASs 12a-12ad. However, to realize the benefits of such a greatly expanded universe of potential peering opportunities, relevant peering opportunities need to be identified and evaluated. Providing infrastructure to enable the identification, evaluation, and/or selection of peering opportunities would remove important obstacles to the realization of the benefits offered by such opportunities.

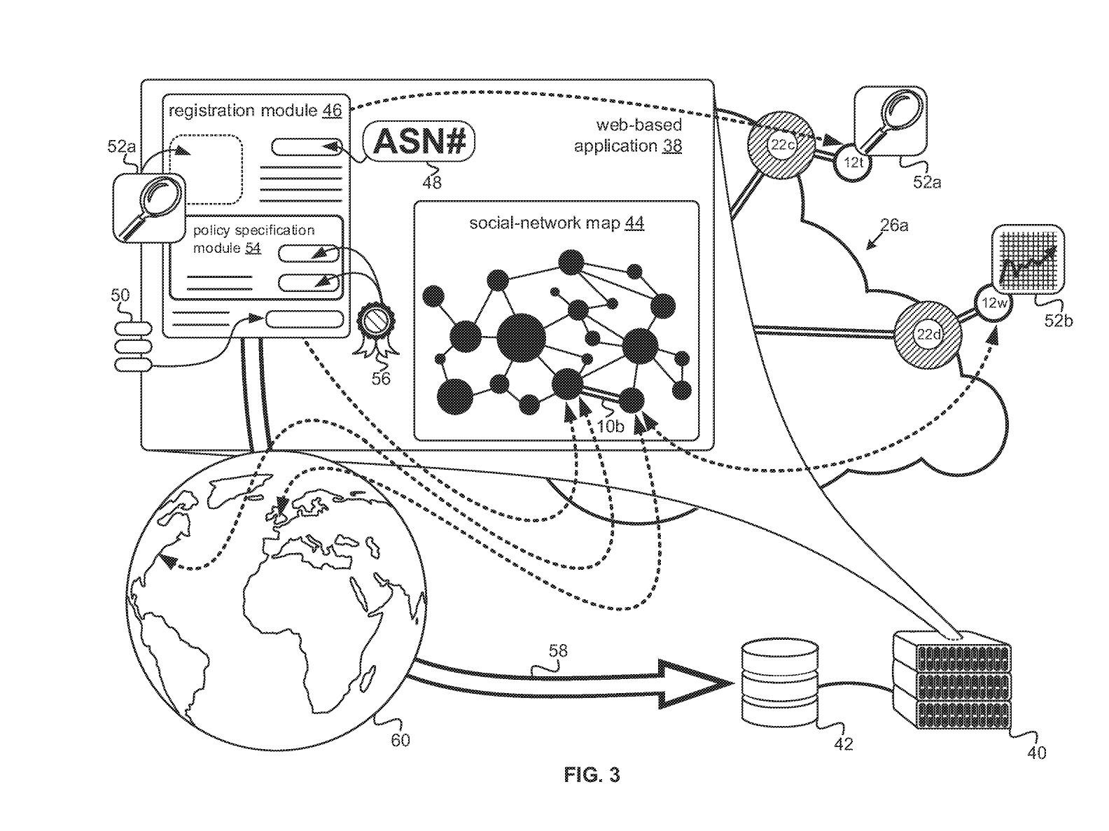

Referring to FIG. 3, a web-based application 38, as depicted, may be deployed with peering infrastructure to facilitate identification, evaluation, and/or selection of peering opportunities. In some examples, the peering infrastructure may be a single, localized IXP 22. Alternatively, the peering infrastructure may include an instance of cloud infrastructure 26a. The web-based application, portal, platform, and/or the like 38 may be hosted by a server system 40 including a set of servers from one to any other number of servers. Also, the web-based application 38 may be communicatively coupled with a database 42 stored on a set of storage devices. The database 42 may store and/or record information about individual, separately-administered networks 12t, 12w registered with the web-based platform 38.

Together, the web-based application 38 and the database 42 may enable the creation of a social-network-like environment. The social-network environment may facilitate peering sessions 10 by collecting and gathering information about separately-administered networks, presenting such information for evaluation by potential peering partners, signaling requests for a peering session 10, providing a space for negotiating a peering session, and/or signaling the implementation of a peering session 10 to related infrastructure, among other contributions. Much like the interconnections facilitated by social networks in other spaces, such as personal or professional networking, with social networking applications like FACEBOOK® and LINKEDIN®, the web-based application 38 and the database 42 may foster analogous interconnections in terms of the resultant peering sessions 10, depicted in FIG. 3 by the social-network map 44, similar to social-network maps that could be generated for social-network applications like FACEBOOK® and LINKEDIN®.

The database 42 in communication with the web-based platform 38 may contribute to the enablement of a social-network environment by providing a means of storing and retrieving information collected, aggregated, and/or amassed for use in the social-network environment. The database 42 may store and/or record information about individual separately-administered networks 12t, 12w registered with the web-based platform 38. In some examples, a registration module 46 may be used to acquire information stored in the database 42.

Throughout this application, the structure and/or functionalities discussed herein may be described as being provided by, occurring at, and/or handled by modules. Modules may take the form of an entirely hardware embodiment, an entirely software embodiment (including firmware, resident software, micro-code, etc.), or an embodiment combining software and hardware aspects. Furthermore, aspects of the presently discussed subject matter may take the form of a computer program product embodied in any tangible medium of expression having computer-usable program code.

With respect to software aspects, any combination of one or more computer-usable or computer-readable media may be utilized. For example, a computer-readable medium may include one or more of a portable computer diskette, a hard disk, a Random Access Memory (RAM) device, a Read-Only Memory (ROM) device, an Erasable Programmable Read-Only Memory (EPROM or Flash memory) device, a portable Compact Disc Read-Only Memory (CDROM), an optical storage device, and a magnetic storage device. In selected embodiments, a computer-readable medium may comprise any non-transitory medium that may contain, store, communicate, propagate, or transport the program for use by or in connection with the instruction execution system, apparatus, or device.

Computer program code for carrying out operations of the present invention may be written in any combination of one or more programming languages, including an object-oriented programming language such as C++, and conventional procedural programming languages, such as the “C” programming language, or similar programming languages. Aspects of a module that are implemented with software may be executed on a micro-processor, Central Processing Unit (CPU) and/or the like. Any hardware aspects of the module may be implemented to interact with software aspects.

The registration module 46, which may be in communication with the web-based application 38, may be operable to collect an ASN 48 and details 50 for a set of metrics used to generate a profile. In such examples, the registration module 46 may include a User Interface (UI), or Graphical User Interface (GUI), accessible over the web-based application 38 and prompting a user of the web-based application 38 to input an ASN 48, other values and/or details 50 for a set of metrics, and/or other information to characterize, describe and/or define, an individual separately-administered network 12. Such a UI, or GUI, may also prompt for additional information, such as a username and/or password. Another example may include an image, or logo, 52a for association with the separately-administered network 12t.

Additionally, in some examples, a policy specification module 54 may be communicatively coupled with the web-based platform 38. The policy specification module 54 may be operable to provide options to characterize an automated peering policy 56 for a separately-administered network 12 upon registration of the separately-administered network 12. For example, the policy specification module 54 may prompt a user of the web-based platform 38 to select from among a set of predefined automated peering policies 56. Additionally, or in the alternative, the policy specification module 54 may allow a user to build an automated peering policy 56 by selecting clauses or provisions, such as, without limitation, by means of one or more drop-down menus.

The web-based application 38, and/or one or more of the associated modules discussed above, may store, save, and/or record 58 the information about the separately-administered network 12 being registered and/or the chosen automated peering policy 56 in the database 42. For example, with respect to an individual, separately-administered network 12, the database 42 may store a profile and/or an automatic peering policy 56. In some examples, the automatic peering policy 56 may be part of the profile.

By way of providing a non-limiting example, FIG. 3 depicts information, such as an ASN 48, values for a set of metrics 50, and even a logo image 52a for a first, separately-administered network 12t as they are into the registration module 46. Additionally, a policy specification module 54 is depicted prompting the selection of provisions for an automated peering policy 56. The corresponding, separately-administered network 12t may be another example of a data analysis network 12t, as suggested by the magnifying glass logo. Perhaps such a network 12 may be located in New York City and be engaged for the processing and/or analysis of large amounts of financial data.

A second image logo 52b for a second, separately-administered network 12w is depicted. The second, separately-administered network 12w may be located in London, England and may be a Content Delivery/Distribution Network (CDN). For example, the second, separately-administered network 12w may be utilized for the collection and/or aggregation of financial data for the London financial markets. As discussed below, the web-based application 38 may serve as a means of introduction for the two networks 12t, 12w, despite the large geographic distance between them indicated on the graphic of the globe 60.

Although both networks 12t, 12w may be connected to local IXPs 22c, 22d to facilitate peering, the geographic distance between the two IXPs 22c, 22d would prevent peering. An instance of cloud infrastructure 26a may be used to overcome geographic obstacles, irrespective of the distances involved, such that a peering session 10b may be established between the two networks 12t, 12w, as depicted in the social-network map 44. Similar interconnections, or peering sessions 10, are depicted in the social-network map 44 for additional networks 12 in the database 42. However, before such peering sessions 10 can be established, participating networks 12 are first presented in a way that enables evaluations of the potential of those networks 12 as potential peering targets.

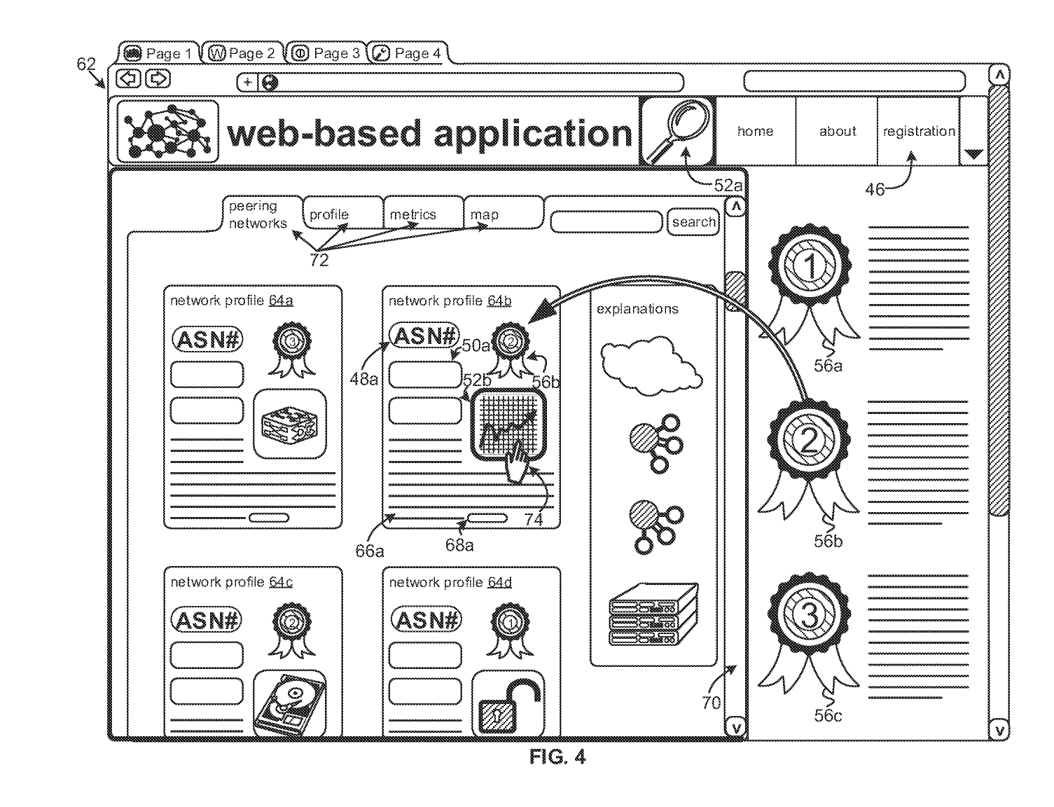

Referring to FIG. 4, a web page 62 generated by the web-based application 38 is depicted. Such a web page 62 may be operable for presenting separately-administered networks 12 in a social-networking manner for evaluation as potential peering targets. In accordance with such an approach, the web-based application 38 may utilize a web page 62 for presentation of various separately-administered network profiles 64a-64d. The web-based application 38 may retrieve information from the database 42 to generate the profiles 64a-64d.

A profile may include an ASN 48a and/or values and/or details 50a addressed to a set of metrics used to characterize the corresponding network 12. A logo, or image, 52b may be included in a profile 64b. Additionally, a written description and/or other additional information 66a may be provided, with further information potentially being accessible by a link, or button 68a. Additionally, the profile 64b, may provide information about an automatic peering policy 56b.

In some examples, the automatic peering policy 56b may be selected from one of three possible automatic peering policies 56a-56c, however, any number of different automatic peering policies 56 are possible. Indeed, as discussed above, in some examples, automatic peering policies 56 may be tailored to individual, separately-administered networks 12. In an example with three automatic peering policies 56a-56c, a first, automatic peering policy 56a may, generally or without reservation, declare a willingness to peer with any other separately-administered network 12 with an interest in entering into such a relationship, possibly subject to certain security or other conditions. A second, automatic peering policy 56b may, for example, include a requirement that a request, which may include certain predetermined information about the requesting network 12, be submitted for approval before a peering session 10 may be established. By way of a third example, an automatic peering policy 56a may limit the number of potential peering partners, such as, without limitation, to a single peering session 10, at any given time. As can be appreciated, any number of different requirements may be imposed by different automatic peering policies 56.

As can be appreciated by the presence of the scroll bar 70, any number of profiles 64 may be presented. In some examples, the web-based application 38 may select profiles 64 for presentation and/or order of presentation by comparing profile attributes to attributes of a separately-administered network 12 associated with a user accessing the web-based application 38. The web-based platform 38 hosted at the system of servers, or server system, 40 may be operable to provide the profiles 64 for multiple ASs 12 registered with the web-based platform 38 with an ASN 48, the profiles providing information to assess the multiple separately-administered networks 12 for peering.

Additionally, the web page 62 may provide links, or tabs, 72 to one or more additional web pages at a common website associated with the original web page 62. These additional web pages may provide explanations, statistics, maps, graphs, and/or additional data useful in interpreting profiles 64 and evaluating corresponding networks 12 as potential peering targets. Additionally, the web-page 62 may include a link to one or more additional services or functionalities, such as those provided by the registration module 46.

As indicated by the logo/image 52a of the magnifying glass in the header of the web page 62, a user, or party, responsible for the first network 12t located in New York and dedicated to the analysis of financial data is depicted as accessing the web page 62, potentially having logged on to the web-based application 38. The user, or responsible party, is depicted as selecting 74 the profile 64b generated for the second, separately-administered network 12w located in London, England and dedicated to collecting and/or aggregating data from the London financial markets. As can be appreciated from the foregoing discussion, the aggregation, collection, storage, and presentation of separately-administered networks 12 provided by a social-networking environment can serve to greatly expand opportunities to identify and evaluate potential peering sessions 10 in ways that remove obstacles to the realization of advantages associated with such peering sessions 10.

However, the identification and/or realization of the advantages by one party to a potential peering session 10 is not itself a full agreement for the peering session 10 or the implementation thereof. Additional obstacles to the realization of the associated advantages arise in the negotiation of the requisite agreement and implementation of a peering session 10. Innovations, discussed, below with respect to the automation of the negotiation of a peering-session agreement and/or the subsequent implementation thereof, however, may be utilized to remove obstacles in these areas.

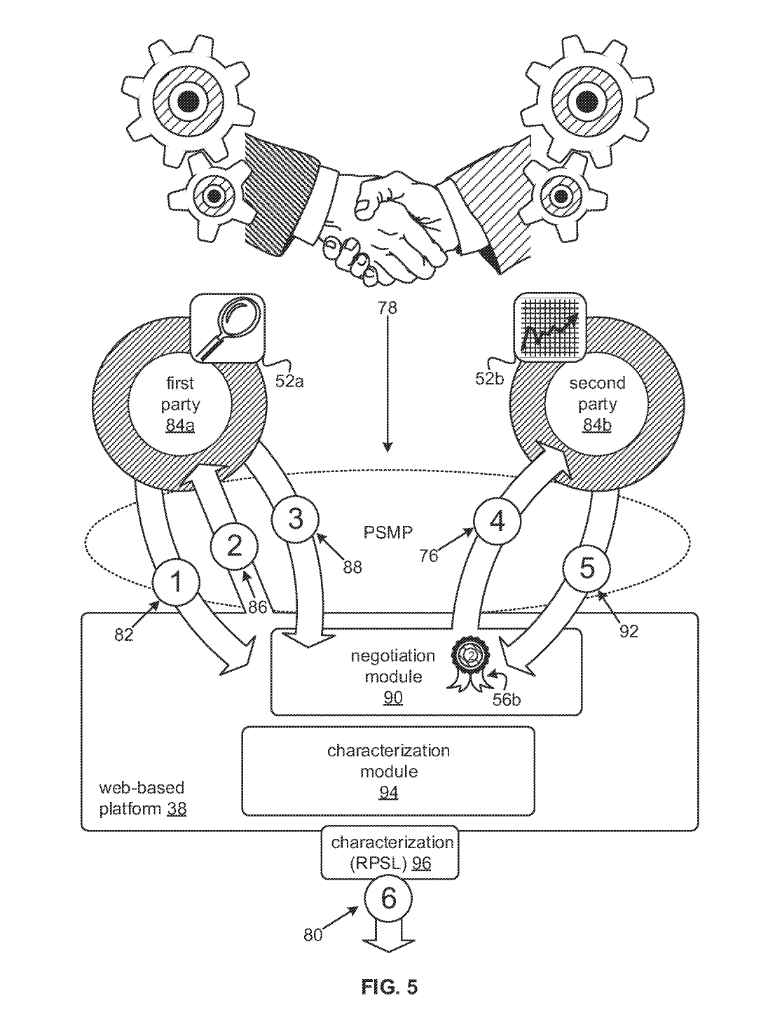

Referring to FIG. 5, innovations related to the automation of a peering request 76 and the negotiation 78 and characterization 80 of a peering session 10, in accordance with examples, are depicted. In some examples, the web-based portal/platform/application 38, and/or one or more modules in communication therewith, may be operable to automatically negotiate a peering session 10b of the first network 12t and the second network 12w by verifying, and/or taking measures to insure, compliance with an automated peering policy 56b of the second network 12w. Negotiation 78 of a peering session 10b may begin with a first step 82 when a first party 84 responsible for the first, separately-administered network 12t accesses a web page 62 generated by the web-based application 38.

The web-based application 38 may, according to a second step 86, provide the profiles 64 recorded in the database 42 and/or other information to enable the responsible party to evaluate separately-administered networks 12 as potential peering targets. A third step 88 may involve identification and/or selection of a peering target. In a scenario consistent with the example introduced with respect to the previous figure, the first responsible party 84a associated with the first, separately-administered network 12t in New York may select the second, separately-administered network 12w in London.

The web-based application 38 and/or a negotiation module 90, communicatively coupled to the web-based portal 38, may capture and/or receive 88 the selection. The negotiation module 90, and/or the web-based application 38, may be operable to automatically negotiate a negotiated peering session 10b between the first, separately-administered network 12t and the second, separately-administered network 12w, and/or the corresponding responsible parties 84a, 84b, by verifying, and/or taking measures to insure, compliance with a second, automated peering policy 56b for the second, separately-administered network 12w. In some examples, the negotiation module 88 may verify, and/or take measures to insure, compliance with both a first, automated peering policy 56 and the first, separately-administered network 12t and a second automated peering policy 56b of the second, separately-administered network 12w. In some examples, the negotiation module 90 and/or the web-based application 38 may verify compliance by determining whether or not the policies of the first, automated peering policy 56 and the second, automated peering policy 56b are compatible.

In some examples, the second automated peering policy 56b, consistent with the example discussed above with respect to the previous figures, may require, according to a fourth step 76, the submission of a request for peering 76. The web-based application 38 and/or the negotiation module 90 may be operable to represent, in a suitable format, and/or send and/or provision the request for peering 76 to the second party 84b, and/or the second, separately-administered network 12w, which request may be accepted or denied. The web-based application 38 and/or the negotiation module 90 may utilize information garnered during the registration of the second, separately-administered network 12w with the web-based application to provision/send the request 76, potentially over a network, to the second party 84b and/or the second, separately-administered network 12w. In some examples, information about the peering request may also be sent 76, providing information with which the second party 84b may evaluate the request. Where the request is accepted, according to a fifth step 92, the web-based application 38 and/or the negotiation module 90, may collect and/or receive 92 the acceptance, and/or verification of acceptance, potentially over a network.

To assist in automation of peering-session implementation after negotiation 78, a characterization module 94 may be communicatively coupled with the web-based platform 38. The characterization module 94 and/or the web-based application 38 may be operable to generate, represent, and/or define, according to a sixth step 80, a characterization/peering-session specification 96 of the negotiated peering session 10b between the first, separately-administered network 12t and the second, separately-administered network 12w, in a generalized language for routing policies. Several different generalized, routing-policy languages may be used, such as, by way of example and not limitation: Representation of IP Routing Policies in a Routing Registry (RIPE-81), such as, without limitation, set forth in RFC-1786; Routing Policy Specification Language (RPSL), such as, without limitation, set forth in RFC-2622 and/or RFC-2650; RPSL-Next Generation), such as, without limitation, set forth in RFC-4012; and/or the like. The web-based application 38 and/or the characterization module 94 may generate the request with profile information 64 and/or ASNs 48 corresponding to the participating networks 12t, 12w in the database 42.

As discussed in greater detail below, the characterization/peering-session specification 96 may be used to provide instructions for implementing the peering session 10b. Since the defining, describing, and/or characterizing 80 the characterization/peering-session specification 96 is performed in a general, routing-policy-characterization language, the characterization 96 does not present obstacles to implementation that may arise because of differing hardware and/or relevant standards. In certain examples, the web-based application 38 automates implementation of a peering session by the preceding six steps, or some combination thereof, in accordance with the Peering Session Management Protocol (PSMP). PSMP, or a similar protocol, may be used to represent and/or send 76 peering requests. By way of providing a non-limiting example, an example subset of such steps may include: providing profiles 64 for the additional networks 12 from the multiple separately-administered networks 12; negotiating 78 the peering session 10b between the first network 12t and the second network 12w by verifying compliance with the automated peering policy 56b of the second network 12w; and characterizing 80 the peering session specification 94 between the first network 12t and the second network 12w.

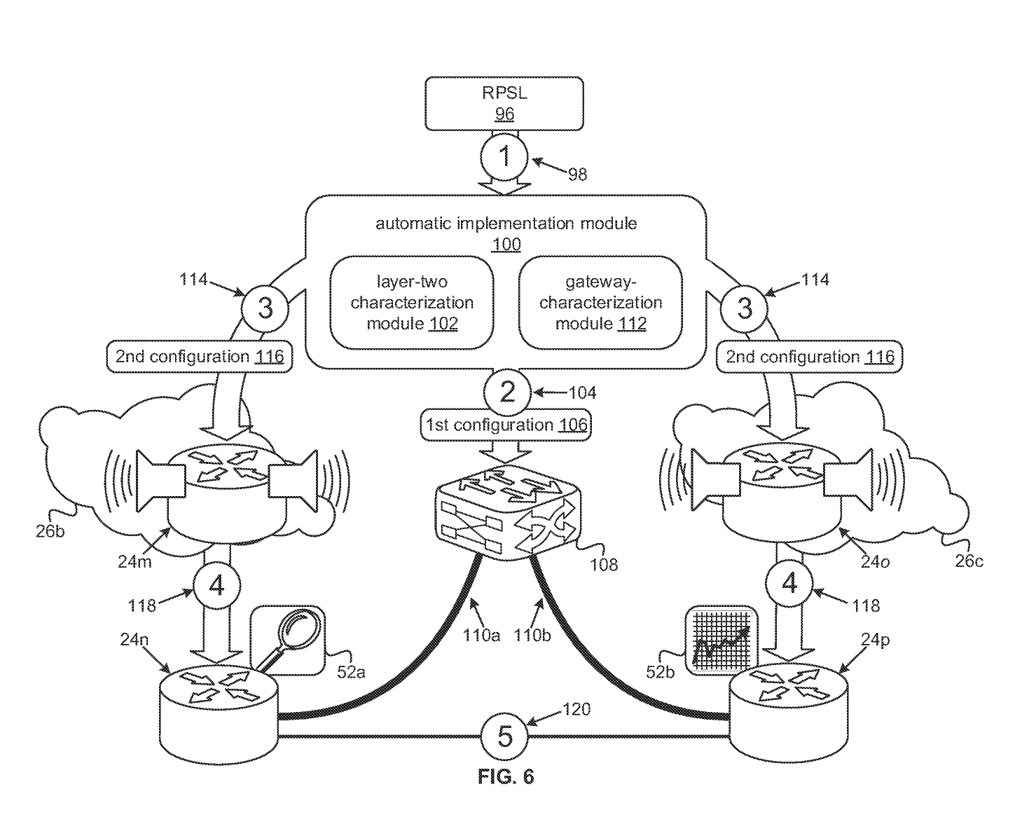

Referring to FIG. 6, further aspects of the automation of a peering session implementation, are depicted. The previously discussed innovations remove obstacles to encountering, identifying, evaluating and selecting peering opportunities and even the generation of instructions to implement such opportunities, but at an abstract level. To further remove obstacles, automation may be extended to the particulars of actual, working implementations.

To enable actual, working implementations, the characterization/peering-session specification 96, providing 98 implementation instructions at a generalized level, to an automatic implementation module, or automation module, 100. The automatic implementation module 100 may be communicatively coupled to the web-based application 38.

Broadly speaking, the automatic implementation module 100 may be operable to translate the peering session specification 96 into implementation information that may be applied on actual hardware. Furthermore, the automatic implementation module 100 may be operable to provision the implementation information to the actual hardware for implementation over networked connections. To achieve actual, working implementations the automatic implementation module 100 may translate the instructions in the characterization 96 into particular instructions to (1) implement a physical connection for the peering session 10b and (2) exchange routing information for the peering session 10b.

With respect to the creation of executable instructions to implement a physical connection, the automation module 100 may include a layer-two configuration module 102, Autonomous-System-level configuration tool 102, and/or exterior-gateway-configuration tool 102. The AS-level configuration tool 102 may be operable to translate 104 the peering session specification 96 into a first configuration 106, such as an AS-level configuration 106. The AS-level configuration 106 may carry information that implements the peering session specification 96 at an AS level. In such examples, the automatic implementation module 100, and/or the automation module 100, may be further operable to provision the AS-level configuration information 106 to hardware 108 operable to provide physical-layer interconnectivity between the first network 12t and the second network 12w. The hardware 108 may be one or more network nodes 108 making up a network-node system 108 to establish and/or maintain physical and/or layer-two connections.

The hardware 108 to which the AS-level configuration information 106 is provided may be a switch, or set of switches, making up a switch system 108. The switch system 108 may be communicatively coupled to the automatic implementation module 100. Furthermore, the switch system 108 may have a first link 110a with the first network 12t and a second link 110b with the second network 12w. In such examples, the AS-level configuration tool 102 may be a layer-two configuration tool 102 operable to define, characterize, describe, and/or represent 104 a Virtual Local Area Network (VLAN) configuration 106 that implements a state represented by the peering session specification/characterization 96. As before, the automatic implementation module 100 and/or the layer-two configuration tool 102 may be further operable to provision, pass, and/or send the VLAN configuration 106 by pushing the VLAN configuration 106 to the switch system 108 to provide a physical-layer connection and/or a layer-two connection between the first, separately-administered network 12t and the second, separately-administered network 12w.

With respect to the creation of executable instructions to exchange routing information for the peering session 10b, the automation module 100 may include a gateway-characterization module 112, or exterior-gateway configuration tool 112. The gateway-characterization module 112 may be operable to define, characterize, describe, and/or represent 114 a peering session 10b between the first, separately-administered network 12t and the second, separately-administered network 12w as a second configuration 116, or distribution configuration 116, implementable to advertise 118 routing information for the peering session 10b by an external gateway protocol. The gateway-characterization module 112 may translate 114 the peering session specification/characterization 96 to define, characterize, describe, and/or represent 114 the peering session 10b into a lower-level configuration 116, such as the second configuration 116, a distribution configuration 116, and/or a fine-grained configuration 116.

The distribution configuration 116 may be implementable, on at least one router 24m, 24o, which may be at least one edge router 24m, 24o, to advertise 118 the routing information for the peering session 10b by an external gateway protocol. The at least one edge router 24m, 24o may be communicatively coupled to the automatic implementation module 100. Furthermore, the automatic implementation module 100 and/or the gateway-characterization module 112 may further be operable to provision the lower-level configuration 116 to at least one edge router 24m, 24o.

In such examples, the at least one router 24m, 24o may also be a set of cloud-based routers 24m, 24o located within one or more portions of a cloud instance 26b, 26c, as discussed above. For example, there may be a first router 24m maintaining an exterior-gateway-protocol session with a second router 24n within the first, separately-administered network 12t and a third router 24o maintaining an exterior-gateway-protocol session with a fourth router 24p within the second, separately-administered network 12w. The set of cloud-based routers 24m, 24o may be operable to receive the distribution configuration 116 and to advertise 118 the routing information for the peering session 10b over the first session and over the second session. The routing information may be used to implement the peering session 10b on routers 24n, 24p in the first network 12t and the second network 12w.

In certain examples, the AS-network-level Gateway Protocol may be the Border Gateway Protocol (BGP). In such examples, the at least one edge router 24m, 24o may serve as at least one BGP speaker 24m, 24o, the exterior-gateway configuration tool 112 may be a BGP configuration tool 112, and the lower-level configuration 116 may be a BGP configuration 116. Additionally, the at least one edge router 24m, 24o may further include at least one routing configuration tool operable to translate the fine-grained configuration 116 into at least one router configuration consistent with a first router 24n of the first network 12t and/or a second router 24p of the second network 12w. The at least one edge router 24m, 24o may also further be operable to push the at least one router configuration to the first router 24n of the first network 12t and/or to the second router 24p of the second network 12w.

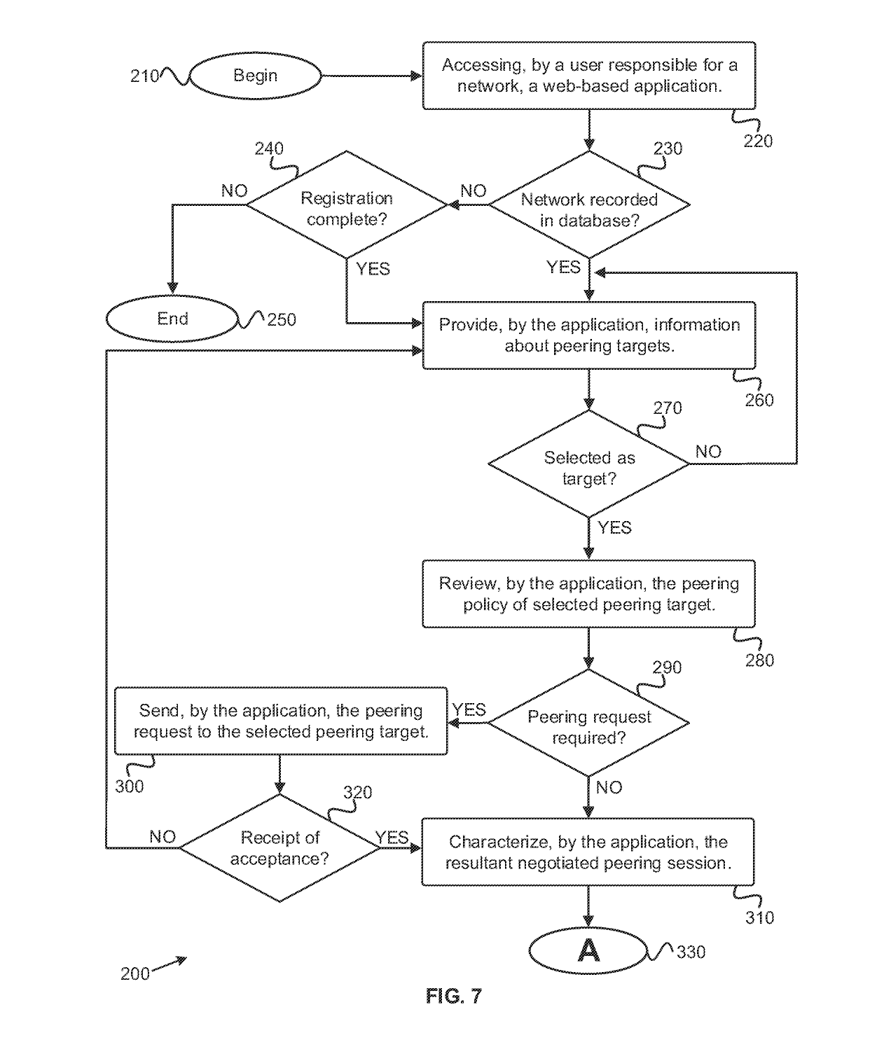

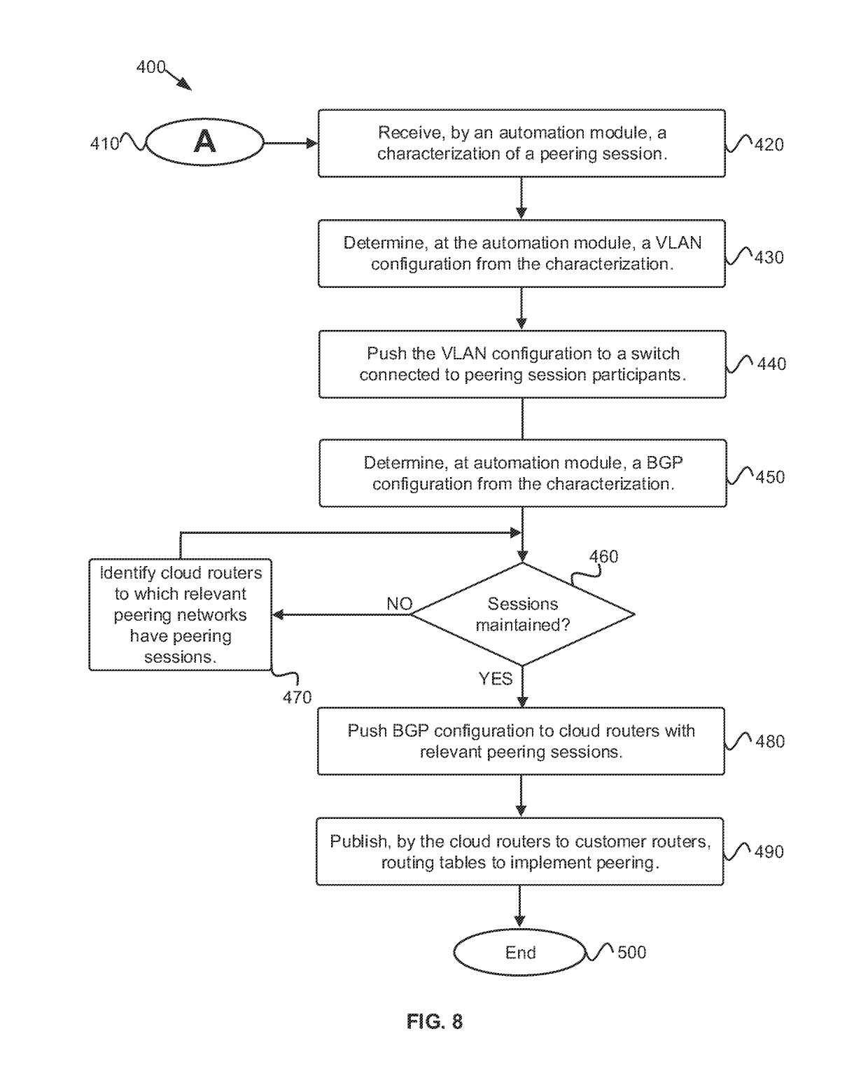

Referring to FIG. 7, a series of steps and determination points 200 are depicted, as a flowchart, for the use of a social-network paradigm for removing obstacles to the establishment of peering sessions 10. The flowcharts in FIG. 7 and FIG. 8 illustrate the architecture, functionality, and/or operation of possible implementations of systems, methods, and computer program products according to examples. In this regard, each block in the flowcharts may represent a module, segment, or portion of code, which comprises one or more executable instructions for implementing the specified logical function(s). It will also be noted that each block of the flowchart illustrations, and combinations of blocks in the flowchart illustrations, may be implemented by special purpose hardware-based systems that perform the specified functions or acts, or combinations of special purpose hardware and computer instructions.

Where computer program instructions are involved, these instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block or blocks. These computer program instructions may also be stored in a computer readable medium that may direct a computer to function in a particular manner, such that the instructions stored in the computer-readable medium produce an article of manufacture including instruction means which implement the function/act specified in the flowchart and/or block or blocks. The computer program may also be loaded onto a computer to cause a series of operation steps to be performed on the computer or other programmable apparatus to produce a computer implemented process for the functions/acts specified in the flowchart and/or block or blocks.

It should also be noted that, in some alternative implementations, the functions noted in the blocks may occur out of the order noted. In certain embodiments, two blocks shown in succession may, in fact, be executed substantially concurrently, or the blocks may sometimes be executed in the reverse order, depending upon the functionality involved. Alternatively, certain steps or functions may be omitted.

As stated, FIG. 7 depicts a social-networking paradigm. Such a paradigm may, in addition to providing a forum for introducing and/or providing information about peering opportunities, may also remove barriers by helping to automate the presentation, negotiation, and characterization of a peering session 10. The steps and/or determinations discussed below may be implemented in any number of configurations with the hardware and/or modules discussed above and/or similar hardware and/or modules.

The series 200 may begin 210, potentially with a user responsible for a separately-administered network 12 accessing 220 the web-based application 38. A determination 230 may be made as to whether information corresponding to the separately-administered network 12 is recorded in a database 42 communicatively coupled with the web-based application 38. If the answer is NO, the web-based application 38 may provide a registration interface and a second determination 240 may be made as to whether the user, or administrator, provides sufficient information to register the separately-administered network 12 with the web-based application 38. If the answer is NO, the series may end 250. If the answer is YES to either the first determination 230 or the second determination 240, the web-based application 38 may provide 260 information about potential peering targets from information about other separately-administered networks 12 recorded in the database 42.

The web-based application 38 may include an event listener acting as another determination 270 as to whether the user, or responsible party, has selected a particular peering target 12 with which to request a peering session 10. If the answer is NO, the web-based application may continue to provide 260 potential peering targets to the responsible party. If the answer is YES, the web-based application 38 may review 280 the automated peering policy 64 of the selected peering target 12, potentially for compatibility with an automated peering policy 64 of the separately-administered network 12 associated with the user.

A determination 290 may be made as to whether the automated peering policy 64 of the selected peering target requires the submission of a peering request. If the answer is YES, the web-based application 38 may format, potentially with PSMP, and send 300 the peering request to the selected peering target network 12, and/or a second party responsible for administration of the selected peering target network 12, for evaluation. If the answer is NO, the web-based application 38 may complete verification of automated-peering-policy compatibility and 310 characterize the negotiated and approved peering session 10 in a routing policy language with a generalized level of abstraction, such as, without limitation, RSPL.

Where the answer to the determination 290 is YES, after sending 300 the request, the web-based application 38 may make an additional determination 320 as to whether the peering request has been accepted. If the answer is NO, the web-based application 38 may return to providing 260 information about potential peering targets. If the answer is YES, the web-based application 38 may proceed to the characterization step 300. After the characterization step 300, the flow of steps and determinations 200 may arrive at an intermediate point 330. The intermediate point 330 may serve as the point of terminus for the flow 200, or as a starting point for additional steps and/or determinations, depending on the example. The following flow chart is consistent with certain examples of scenarios where the intermediate point 330 serves as a point of continuation. However, the steps and determinations of the following flow chart may also have an independent origin.

Referring to FIG. 8, a flow 400 of steps and/or determinations for automating a peering session 10 in an actual networking environment are depicted. The flow 400 may begin 410 independently or as a continuation of a previous flow of steps and/or determinations, such as a continuation from the intermediate point 330 discussed with respect to the previous figure. After commencement, the automation module 100 may receive 420 a characterization 96 of an implementation of a peering session 10.

The automation module 100 may determine 430 a VLAN configuration 116 from the characterization 96 and/or push 440 the VLAN configuration 116 to a switch 108 connected to peering session participants 12. The automation module 100 may also determine 450 a BGP configuration 116 from the characterization 96. Prior to pushing 440 the BGP configuration 116 to a set of routers 24 with which to advertise routing information for the peering session 10, the automation module 100 may determine 460 if the set of routers 24 maintains sessions with the separately-administered networks 12 participating in the anticipated peering session 10.

If the answer is NO, the automation module 100 may proceed to identify 470 cloud routers 24 maintaining sessions with the separately-administered networks 12 designated for participation in the peering session 10. After identifying 470 the routers 24, or if the answer to the determination 460 is YES, the automation module 100 may push 480 the BGP configuration 116 to the cloud routers 24 maintaining the sessions. The cloud routers 24 may then publish 490 routing tables to implement peering and the flow 400 may end 500.

The present disclosures may be embodied in other specific forms without departing from their spirit or essential characteristics. The described examples are to be considered in all respects only as illustrative, not restrictive. The scope of the invention is, therefore, indicated by the appended claims, rather than by the foregoing description. All changes within the meaning and range of equivalency of the claims are to be embraced within their scope.

1. A system to automate peering sessions between separately-administered networks:
a switch system supporting a physical communication layer between a pair of networks selected from multiple separately-administered networks connected to the switch system ports;
a database, on storage devices, storing profiles, for the multiple separately-administered networks, comprising an Autonomous System Number (ASN) and an automated peering policy;
a web-based application, on a database-coupled server system, enabling interconnections between separately-administered networks in a social-network manner by being operable to:
provide, to a party responsible for a first network, profiles for additional networks, each network from the multiple separately-administered networks;
represent a peering request to a second network selected, by the party, from the additional networks, to peer with the first network;
automatically negotiate a peering session of the first network and the second network by verifying compliance with an automated peering policy of the second network; and
define a peering session specification for the first network and the second network, with corresponding profiles and ASNs in a generalized routing-policy language.

2. The system of claim 1, further comprising an automatic implementation module operable to:
receive the peering session specification;
translate the peering session specification into implementation information; and
provision the implementation information to hardware for implementation.

3. The system of claim 2, further comprising:
an AS-level configuration tool within the automatic implementation module, the AS-level configuration tool operable to translate the peering session specification into AS-level configuration information that implements the peering session specification at an AS level; and wherein:
the automatic implementation module is further operable to provision the AS-level configuration information to hardware operable to provide physical-layer interconnectivity between the first network and the second network.

4. The system of claim 2, wherein the switch system is communicatively coupled to the automatic implementation module, the switch system having a first link with the first network and a second link with the second network; and wherein
the automatic implementation module:
further comprises a layer-two configuration tool operable to define a Virtual Local Area Network (VLAN) configuration that implements a state represented by the peering session specification; and
is further operable to provision the VLAN configuration by pushing the VLAN configuration to the switch system to provide a physical layer connection and a layer-two connection between the first network and the second network.

5. The system of claim 4, further comprising an exterior-gateway configuration tool within the automatic implementation module, the exterior-gateway configuration tool operable to:
translate the peering session specification into a lower-level configuration for an AS-network-level Gateway Protocol (AGP) implementable to advertise routing information that implements the peering session specification on routers in the first network and the second network; and
the automatic implementation module is further operable to provision the lower-level configuration to at least one edge router, the at least one edge router operable to provide routing information to a first router in the first network and a second router in the second network.

6. The system of claim 5, wherein the AGP is Border Gateway Protocol (BGP), the at least one edge router serves as at least one BGP speaker, the exterior-gateway configuration tool is a BGP configuration tool, and the lower-level configuration is a BGP configuration.

7. The system of claim 2, further comprising at least one edge router communicatively coupled to the automatic implementation module and maintaining sessions with a first router in the first network and a second router in the second network; and
wherein the automatic implementation module further comprises an exterior-gateway-configuration tool operable to translate the peering session specification into a fine-grained configuration for an AGP;
the at least one edge router further comprises a routing configuration tool operable to translate the fine-grained configuration into at least one router configuration consistent with a first router of the first network and a second router of the second network; and
the at least one edge router is further operable to push the at least one router configuration to the first router of the first network and to the second router of the second network.

8. The system of claim 1, wherein the generalized routing-policy language is Routing Policy Specification Language (RPSL) and the peering session specification is an RPSL characterization.

9. The system of claim 1, wherein the automated peering policy of the second network requires a submission of information about a peering request and the web-based application is further operable to:
send the information about the peering request to the second network; and
receive verification of acceptance of the peering request from the second network before characterizing a peering session specification between the first network and the second network.

10. The system of claim 1, wherein the web-based application automates implementation of Peering Session Management Protocol (PSMP) by providing profiles for the additional networks from the multiple separately-administered networks, negotiating the peering session between the first network and the second network by verifying compliance with the automated peering policy of the second network, and characterizing the peering session specification between the first network and the second network.

11. The system of claim 1, further comprising a registration module in communication with the web-based application and operable to collect an ASN and details for a set of metrics used to generate a profile for use in presenting a separately-administered network as a potential peering target in a social-networking manner.

12. A system for automating peering sessions between autonomous networks comprising:
a web-based portal hosted by a server system and operable to define, in a general, routing-policy-characterization language, a characterization of a negotiated peering session between a first Autonomous System (AS) and a second AS;
a first router maintaining an exterior-gateway-protocol session with a second router within the first AS and a third router maintaining an exterior-gateway-protocol session with a fourth router within the second AS;
a networking-node system operable to maintain a physical connection with the first AS and with the second AS;
an automation module operable to translate, from the characterization, a first configuration implementable to provide a physical connection between the first AS and the second AS and to push the first configuration to the networking-node system; and
the automation module is further operable to translate, from the characterization, and to provision, a second configuration implementable at the first and the third routers to advertise routing information to the second router and the fourth router by an AS-network-level Gateway Protocol (AGP).

13. The system of claim 12, further comprising a negotiation module communicatively coupled to the web-based portal, the negotiation module operable to automatically negotiate the negotiated peering session between the first AS and the second AS by verifying compliance with a first automated peering policy of the first AS and a second automated peering policy of the second AS.

14. The system of claim 12, wherein the first router and the third router implement a routing configuration tool operable to translate the second configuration into routing policy information usable by the second router and the fourth router respectively.

15. The system of claim 12, wherein the AGP is Border Gateway Protocol, the first and the third routers serve as BGP speakers, the automation module comprises a BGP configuration tool, and the second configuration is a BGP configuration.

16. A system for automating peering between networks:
a web-based platform hosted at a server system and operable to provide profiles for multiple separately-administered networks registered with the web-based platform with an Autonomous System Number (ASN), the profiles providing information to assess the multiple separately-administered networks for peering;
a negotiation module communicatively coupled with the web-based platform and operable to automatically verify compliance with a first automated peering policy for a first, separately-administered network and a second automated peering policy for a second, separately-administered network selected for peering;
a gateway-characterization module communicatively coupled with the web-based platform and operable to characterize a peering session between the first, separately-administered network and the second, separately-administered network as a distribution configuration implementable to advertise routing information for the peering session by an External Gateway Protocol (AGP); and
a set of cloud-based routers maintaining a first session with a first router in the first, separately-administered network and a second session with a second router in the second, separately-administered network, the set of cloud-based routers operable to receive the distribution configuration and to advertise the routing information for the peering session over the first session and over the second session.

17. The system of claim 16, further comprising a layer-two configuration module operable to characterize a layer-two configuration and to pass the layer-two characterization to a network node, the layer-two configuration implementable at the network node to establish a physical and a layer-two connection between the first, separately-administered network and the second, separately-administered network.

18. The system of claim 16, further comprising:
a characterization module communicatively coupled with the web-based platform and operable to generate a characterization of the peering session between the first, separately-administered network and the second, separately-administered network, in a generalized language for routing policies; and wherein
the gateway-characterization module translates the characterization to characterize the peering session as the distribution configuration implementable to advertise the routing information for the peering session by the AGP.

19. The system of claim 16, further comprising a policy specification module communicatively coupled with the web-based platform and operable to provide options to characterize an automated peering policy for a separately-administered network upon registration of the separately-administered network.

20. The system of claim 16, further comprising a database on a set of storage devices, the database communicatively coupled with the web-based platform and recording a profile and an automatic peering policy for individual separately-administered networks registered with the web-based platform.
